(19) United States
(12) Patent Application Publication
(10) Pub. No.: US 2018/0079978 A1
(43) Pub. Date: Mar. 22, 2018

(54) Rotary Grate for a Fixed-Bed Gasifier that Produces a Product Gas from Hydrocarbon-Containing Feedstock

(71) Applicant: Entrade Energiesysteme AG, Duesseldorf (DE)

(72) Inventors: Horst Dressler, Dietfurt (DE); Michael Hofmeister, Rinchnach (DE)

(21) Appl. No.: 15/810,132

(22) Filed: Nov. 12, 2017

Related U.S. Application Data
(63) Continuation-in-part of application No. PCT/EP2016/060358, filed on May 9, 2016.

(30) Foreign Application Priority Data
May 13, 2015 (DE) 102015208923.1
May 9, 2016 (EP) PCT/EP2016/060358

(51) Int. Cl. C10J 3/42; C10B 53/02; B04C 5/081; F23C 5/32

(52) U.S. Cl. CPC C10J 3/42; C10B 53/02; B04C 5/04; F23C 5/32; B04C 5/081

(57) ABSTRACT

A rotary grate with slit-shaped openings is used in fixed-bed gasifier that produces a product gas from biomass particles. The rotary grate supports the biomass particles. Each slit-shaped opening has a cross-section that conically widens in the direction from the upper to lower side of the grate. The slit-shaped openings act as planes to break up ash supported by the grate as a drive shaft rotates the grate. As the grate rotates, a dome-shaped covering in the middle of the grate causes ash to be spun laterally away from the middle and into the region of the grate where the slit-shaped openings are located. The slit-shaped openings extend concentrically around the middle of the grate. The combined open area of the slit-shaped openings on the upper side of the grate makes up between 20% to 40% of the grating surface area outside the dome-shaped covering on the upper side.

### CROSS REFERENCE TO RELATED APPLICATION

This application is filed under 35 U.S.C. § 111(a) and is based on and hereby claims priority under 35 U.S.C. § 120 and § 365(c) from International Application No. PCT/EP2016/060358, filed on May 9, 2016, and published as WO 2016/180793 A1 on Nov. 17, 2016, which in turn claims priority from German Application No. 102015208923.1, filed in Germany on May 13, 2015. This application is a continuation-in-part of International Application No. PCT/EP2016/060358, which is a continuation of German Application No. 102015208923.1. International Application No. PCT/EP2016/060358 is pending as of the filing date of this application, and the United States is an elected state in International Application No. PCT/EP2016/060358. This application claims the benefit under 35 U.S.C. § 119 from German Application No. 102015208923.1. The disclosure of each of the foregoing documents is incorporated herein by reference.

### TECHNICAL FIELD

The invention relates to a rotary grate for producing a product gas from hydrocarbon-containing feedstock in a fixed-bed gasifier.

### BACKGROUND

Fixed-bed gasifiers that produce a combustible product gas from biomass pellets, such as wood chips or wood pellets, are characterized by a comparatively simple design. A distinction exists between countercurrent gasifiers and downdraft gasifiers. In a countercurrent gasifier, the combustion air and the product gas flow in a direction opposed to the feed-in direction of the biomass particles. In a downdraft gasifier, however, the feed-in direction of the biomass particles matches the flow direction of combustion air and product gas. Fixed-bed gasifiers have different reaction zones, such as a drying zone, a pyrolysis zone, an oxidation zone and a reduction zone, in which different thermochemical reactions take place.

An overview on the subject of fixed bed gasification of biomass particles was disclosed by Lettner, Haselbacher and Timmerer from the Technical University of Graz, Austria, in the presentation entitled “Festbett-Vergasung—Stand der Technik (Überblick)” (an overview of the state of the art of fixed bed gasification) given on Feb. 27, 2007 at the conference in Leipzig entitled “Thermo-chemische Biomasse-Vergasung für eine effiziente Strom/Kraftstoffbereitstellung—Erkenntnisstand 2007” (thermo-chemical biomass gasification for efficient current/fuel supply—state of the art in 2007). The presentation describes a downdraft shaft gasifier in which the biomass particles are supplied into the gasifier container from above using gravity. In the middle area of the gasifier, combustion air is supplied via nozzles, and the product gas is discharged from the lower area of the gasifier container. A drying zone, a pyrolysis zone, an oxidation zone and a reduction zone are arranged from top to bottom in this known fixed-bed gasifier. The oxidation zone is located within the area of the air supply and is to be restricted to that zone. The reduction zone is beneath the oxidation zone and is directly above the grate. The product gas is removed from the area of the gasifier container beneath the grate, through which small particles of ash fall and are collected.

The openings in the grate, on the one hand, have to be small enough for pourable biomass particles to be supported by the grate and, on the other hand, large enough for ash particles and product gas to pass through. If the openings become too large, there is the danger that biomass particles will fall through or become lodged in the openings. The lodged biomass particles together with ash particles may lead to clogging of the openings. The openings may also become clogged with molten ash or tar. The problem of particles sitting on the top becoming clogging in openings in the grate is even more critical because the product gas must flow downwards through the grate from top to bottom instead of from the bottom upwards through the grate.

The German patent DE 2927240 A discloses a fixed-bed gasifier that produces a product gas from pourable biomass particles in which ash and slag are removed from the reactor container through a discharge conveyor in the form of a motor-driven rotary grate that is positioned on the bottom of the reactor. The diameter of the grate is smaller than the inner diameter of the reactor container so that a ring gap remains at the edge of the reactor container through which solid particles can enter a vent. The discharge conveyer includes a plurality of disks of different diameters that are used to break up ash and slag.

It is an object of the present invention to improve upon the disclosure of German patent DE 2927240 A by providing a grate through which particles and gas can better flow downward from above. The novel grate is intended to support the biomass particles and to draw off ash and product gas with a reduced tendency for the openings in the grate to become clogged. Moreover, it is also an object of the present invention to provide a fixed-bed gasifier with such a grate.

### SUMMARY

The invention provides a grate that can be flowed through from above and is intended for supporting the biomass particles and for drawing off ash and product gas, with a reduced tendency for the openings in the grate to become clogged. A fixed-bed gasifier containing such a grate is also part of the invention. When rotated the grate acts as a plane so that lumps of ash and slag are broken up and forced through the slit-shaped openings by the rotational movement. The slit shape of the openings means that, in spite of a large passing-through area, even small biomass particles can be supported. The conical shaping of the openings in the rotary grate reduces the tendency of the slit-shaped openings to become clogged and impassable to ash and product gas, and the slit-shaped openings act as a plane. The central dome-shaped covering prevents any accumulation of ash or slag in the middle of the grate being caused by the grate moving little or not at all with respect to biomass particles in the middle. Moreover, there may be no openings in the middle because the drive shaft is attached at the middle of the grate. The dome-shaped configuration of the covering means that the rotation of the grate causes ash and slag to be thrown off laterally so that they are transported into the region with the slit-shaped openings.

A rotary grate with slit-shaped openings is used in a fixed-bed gasifier that produces a product gas from hydrocarbon-containing feedstock, such as biomass particles. The rotary grate includes a disk-shaped main part, a dome-shaped covering and a central drive shaft. The disk-shaped main part is adapted to support the hydrocarbon-containing feedstock inside the fixed-bed gasifier. Each of the slit-shaped openings has a cross-section that conically widens in a direction from the upper side to the lower side of the disk-shaped main part. The slit-shaped openings are adapted to act as a plane to break up objects disposed on the upper side of the disk-shaped main part as the central drive shaft rotates the disk-shaped main part. One end of the central drive shaft is fixedly attached to the middle of the disk-shaped main part, and the other end of the central drive shaft is connected to a motor drive. The dome-shaped covering is disposed in the middle of the disk-shaped main part and is attached to the upper side of the disk-shaped main part opposite to where the central drive shaft is attached to the lower side of the disk-shaped main part.

The slit-shaped openings extend concentrically around the middle of the disk-shaped main part and are radially distributed over the disk-shaped main part. The upper side of the disk-shaped main part outside the dome-shaped covering provides a grating surface area. A combined open area that is formed by the slit-shaped openings on the upper side of the disk-shaped main part makes up between 20% to 40% of the grating surface area on the upper side of the disk-shaped main part.

A fixed-bed gasifier for producing a product gas from biomass particles includes a gasifier container, a biomass supply inlet, an air supply inlet, a product gas vent and a rotary grate. The supply inlet is adapted to receive the biomass particles into the fixed-bed gasifier. The rotary grate is adapted to support the biomass particles and is disposed in a lower portion of the gasifier container. Combustion air enters the gasifier container through the air supply inlet. Product gas generated from the biomass particles exits the gasifier container through the product gas vent. The product gas vent leads out of the gasifier container below the rotary grate.

Each of the slit-shaped openings has a cross-section that conically widens in a direction from the upper side to the lower side of the rotary grate. The slit-shaped openings are adapted to act as a plane as the rotary grate rotates to break up ash from the biomass particles that is supported by the rotary grate. The rotary grate has a diameter that is smaller than the inner diameter of the gasifier container such that a ring gap remains between the rotary grate and the inner wall of the gasifier container. A ring is disposed in the ring gap and is supported from the lower cover of the gasifier container by pillared supports. Pillared inserts are disposed inside the gasifier container and extend from the ring to the upper cover of the gasifier container.

Other embodiments and advantages are described in the detailed description below. This summary does not purport to define the invention. The invention is defined by the claims.

### BRIEF DESCRIPTION OF THE DRAWING

The accompanying drawings, where like numerals indicate like components, illustrate embodiments of the invention.

FIG. 1 is a schematic, cross-sectional view of an exemplary embodiment of a fixed-bed gasifier including a temperature measurement device and rotary grate.

FIG. 2 is a perspective view onto an exemplary configuration of a rotary grate for a fixed-bed gasifier.

FIG. 3 a cross-sectional view along the line A-A of FIG. 2.

### DETAILED DESCRIPTION

Reference will now be made in detail to some embodiments of the invention, examples of which are illustrated in the accompanying drawings.

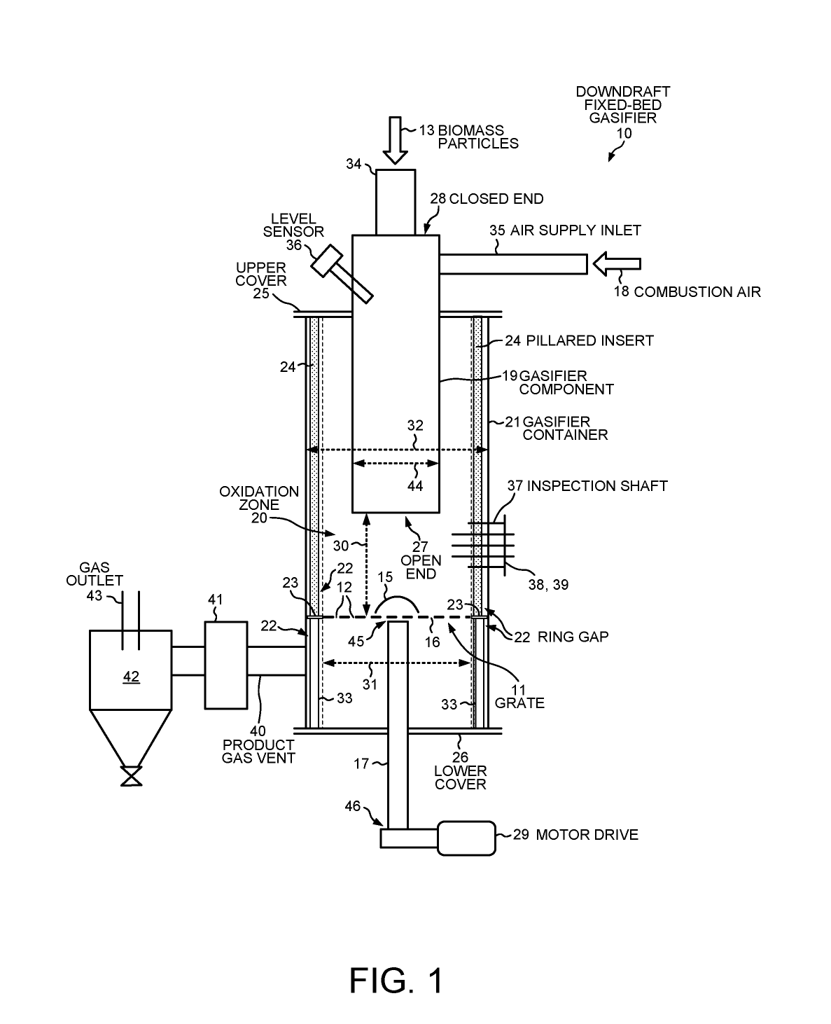

FIG. 1 is a schematic diagram of an exemplary embodiment of a downdraft fixed-bed gasifier 10 with a rotary grate 11 according to the present invention. The dimensioning and positioning of the slit-shaped openings 12 in the grate 11 provide various advantages. The rotation of the grate 11 acts as a plane such that lumps of ash and slag are broken up and forced through the slit-shaped openings 12 by the rotational movement. The elongated slit shape of the openings means that despite the large passing-through area of each opening, even small biomass particles 13 are supported and do not fall through. The conical shape 14 of the slit openings 12 in the rotary grate 11 allows the grate to act as a plane and thereby reduces the risk that the slit-shaped openings will become clogged to ash and product gas. The central dome-shaped covering 15 prevents any accumulation of ash or slag in the middle of the main part 16 of the grate 11, which would result in the grate moving little or not at all with respect to the biomass particles 13 in the middle. The middle of the grate 11 is also covered because there are no openings 12 in the middle where the drive shaft 17 is attached or mounted to the grate 11. The dome-shaped configuration of the covering 15 means that the rotation of the grate 11 causes ash and slag to be thrown off laterally so that they are transported into the region with the slit-shaped openings 12.

By rotating the grate 11, the slit-shaped openings 12 can be prevented from becoming clogged during the operation of the fixed-bed gasifier 10 that produces product gas from hydrocarbon-containing feedstock, such as pourable biomass particles 13. The product gas is typically wood gas or a gas mixture containing hydrogen gas, carbon monoxide and methane. By varying the rotating speed of the grate 11 and the time intervals during which the grate 11 is rotated, the grate 11 can be prevented from becoming clogged even during operation of the fixed-bed gasifier 10 under unfavorable conditions.

An embodiment of a downdraft, fixed-bed gasifier 10 allows for safe and stable process control and generates a continuous flow of product gas with low tar quantities. Combustion air 18 is channeled down through a cylindrical gasifier component 19 and into the bed of biomass particles 13, which results in a uniform distribution of the combustion air 18. When viewed from a cross-section, hardly any temperature differences occur in the oxidation zone 20 of the gasifier container 21 by virtue of the uniform distribution. As a result, even pyrolysis gases generated above the oxidation zone 20 flow through the oxidation zone in a uniform manner. The uniformity of the gas and air flows allows a product gas to be produced that has low quantities of tar. For additional details on such a configuration of the fixed-bed gasifier 10, see U.S. Patent Application Publication 2017/0275543, which claims priority to German application DE102014225166.4, the subject matter of which is incorporated herein by reference.

The fixed-bed gasifier 10 is designed with a ring gap 22 between the outer circumference of the grate 11 and the inner wall of the gasifier container 21. A ring 23 covers the ring gap 22. The ring gap 22 thermally decouples the grate 11 from the gasifier container 21. The flow speed of the gases and air in the fixed-bed gasifier 10 can be controlled by varying the width of the circumferential ring 23.

The flow speed of the gases and air in the fixed-bed gasifier 10 can additionally be controlled by using various inserts 24 in the gasifier container 21. The pillared or elongated cylindrical inserts 24 also provide thermally insulation to the gasifier container 21. The various pillared inserts 24 are part of a modular assembly system that allows each particular gasifier container 21 to be specially modified.

FIG. 1 is a schematic view of an exemplary configuration of the fixed-bed gasifier 10 in accordance with the present invention. The fixed-bed gasifier 10 includes the cylindrical gasifier container 21, the ends of which are closed by an upper cover 25 and a lower cover 26. The cylindrical gasifier component 19 has a lower open end 27 and an upper closed end 28. The open end 27 of the gasifier component 19 projects down through the upper cover 25 into the gasifier container 21. The closed end 28 of the gasifier component 19 protrudes up through the upper cover 25 out of the gasifier container 21. The open end 27 of gasifier component 19 lies approximately at the center of the gasifier container 21. The rotary grate 11 is attached to the drive shaft 17 and is periodically rotated by a motor drive 29. The drive shaft 17 passes through the lower cover 26 of the gasifier container 21. The grate 11 is arranged at a distance 30 beneath the open end 27 of gasifier component 19.

Because the diameter 31 of the grate 11 is smaller than the inner diameter 32 of the gasifier container 21, a ring gap 22 remains between the outer circumference of the grate 11 and the wall of the gasifier container 21. The ring gap 22 is covered by a circumferential ring 23 that is attached to the lower cover 26 of the gasifier container 21 by supports 33. By placing the ring 23 between the grate 11 and the wall of the gasifier container 21, the grate 11 is thermally decoupled from the gasifier container 21. In addition, the flow speed of the gases and air through the fixed-bed gasifier 10 can be controlled by the width of circumferential ring 23.

The flow speed of the gases and air through the fixed-bed gasifier 10 can also be influenced by placing elongated, pillared inserts 24 between the gasifier container 21 and gasifier component 19. In one embodiment, the pillared inserts 24 are inserted above the level of the grate 11 and extend to the upper cover 25 of the gasifier container 21. In another embodiment, the pillared inserts 24 extend from the lower cover 26 to the upper cover 25. The pillared inserts 24 also thermally insulate the gasifier container 21. The inserts 24 allow the fixed-bed gasifier 10 to be made in a modular assembly system, in which a particular gasifier component 20 can be specially modified.

The upper, closed end 28 of the gasifier component 19 is penetrated by a supply inlet 34 for carbon-containing input substances such as the pourable biomass particles 13, an air supply inlet 35 through which combustion air 18 enters the gasifier container 21, and a level sensor 36 by which the level of biomass particles 13 in the cylindrical gasifier component 19 is determined and monitored. The upper, closed end 28 of the gasifier component 19 projects up and out of the gasifier container 21. An inspection shaft 37 penetrates the outer wall of the gasifier container 21 at the level of the open end 27 of the gasifier component 19. The inspection shaft 37 is closed by a covering flange 38 that is part of a temperature measurement device 39. The temperature in the gasifier container 21 is monitored using the temperature measurement device 39. Access into the reactor vessel can be gained through the inspection shaft 37 in order to perform maintenance and cleaning work inside the reactor vessel during the standstill of the reactor.

The product gas is removed from the region of the gasifier container 21 beneath the grate 11 through a product gas vent 40. The product gas is then cooled in a heat exchanger 41 and purified in a downstream cyclone separator 42. The ashes falling through the grate 11 are also discharged from the fixed-bed gasifier 10 through the product gas flow via the product gas vent 40. The product gas from which the ash and other particles have been separated then exits the gas outlet 43 of the cyclone separator 42.

Both the cylindrical gasifier container 21 and the cylindrical gasifier component 19 have a circular cross-section and are arranged concentrically to one another. The cylindrical gasifier component 19 has an inner diameter 44 that is smaller than the inner diameter 32 of the cylindrical gasifier container 21.

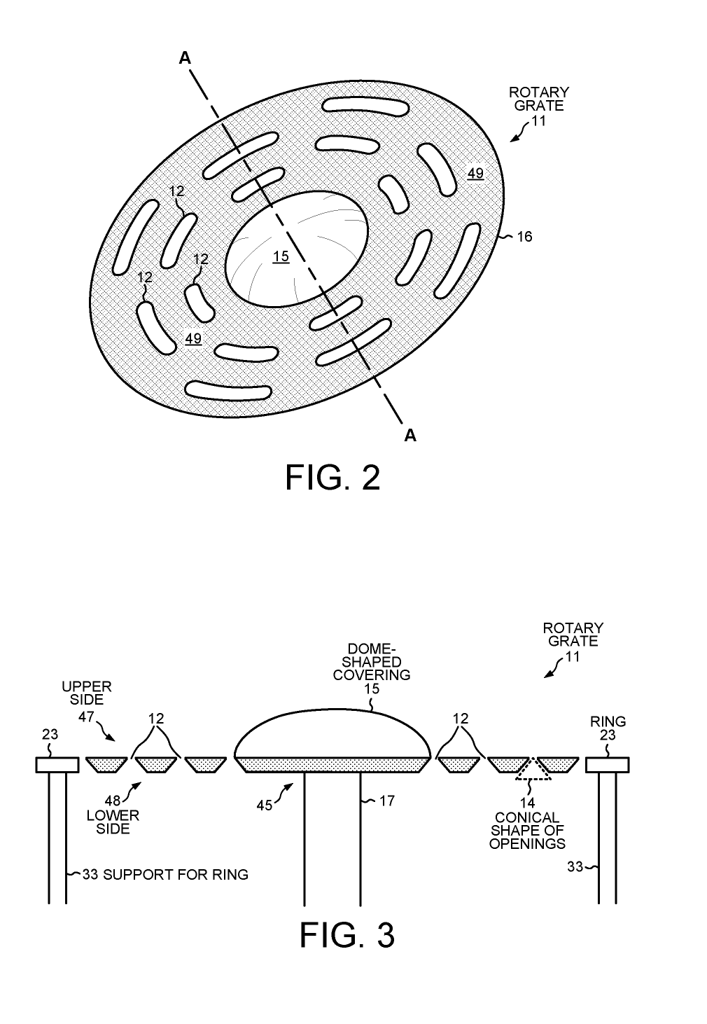

FIGS. 2-3 show additional details of the rotary grate 11 of the fixed-bed gasifier 10 of FIG. 1. FIG. 2 shows that the rotary grate 11 has a disk-shaped main part 16 that supports the hydrocarbon-containing feedstock, such as the biomass particles 13. The main part 16 is mounted centrally onto the drive shaft 17. The drive shaft 17 has a first end 45 and a second end 46. The first end 45 of the drive shaft 17 is connected to the center of the main part 16 of the grate 11. The second end 46 is connected to the motor drive 29. The drive shaft 17 penetrates the lower cover 26 of the gasifier container 21. The motor drive 29 is used to rotate the grate 11 at different times and for various lengths and at different angular velocities.

FIG. 2 shows the plurality of slit-shaped openings 12 formed in concentric circles around the middle of the disk-shaped main part 16 of the grate 11 that allow ashes and product gas to pass through the grate. The slit-shaped openings extend concentrically around the middle of the main part 16 and are radially distributed over the main part 16. The upper side 47 of the disk-shaped main part 16 outside the dome-shaped covering 15 provides the grating surface area 49. The combined open area formed by the slit-shaped openings 12 on the upper side 47 of the disk-shaped main part 16 makes up between 20% to 40% of the grate surface area 49 on the upper side 47 of the disk-shaped main part 16.

FIG. 3 is a cross-sectional view of the openings 12, which form conical shapes 14 in the cross-sectional view. The openings 12 conically widen from the upper side 47 to the lower side 48 of the main part 16 of grate 11. The conical shape of the openings 12 both reduces clogging and breaks up larger chunks of ash. The conical shape of the openings 12 reduces the probability that lumps of ash and slag will clog the openings 12 because the smallest location of the openings 12 is on the upper side 47. A particle that can pass through the thin slit will fall through the grate 11 and will not become jammed between two walls. In addition, the conical configuration of openings 12 acts like a plane that upon rotation of the grate 11 “planes off” ash, charcoal and slag and thereby moves them from the upper side 47 to the lower side 48 of the main part 16 of the grate 11.

The dome-shaped covering 15 is located in the middle of the upper side 47 of the main part 16 above the rotational shaft 17. The dome-shaped covering 15 prevents any accumulation of ash and slag in the middle of the main part 16 that would otherwise build up because the middle of the rotating grate 11 is moving very little with respect to the bed of biomass particles 13. Ash would otherwise also build up in the middle because there are no openings 12 in the middle of main part 16 where the drive shaft 17 is attached or mounted to the grate 11. The dome-shaped configuration of the covering 15 causes ash and slag to be spun laterally away from the center as the motor drive 29 and drive shaft 17 rotate the grate 11. The ash and slag are thereby moved into the region of the main part 16 where the slit-shaped openings 12 are located.

### REFERENCE NUMERALS

10 down-draft fixed-bed gasifier
11 rotary grate
12 slit-shaped openings
13 biomass particles
14 conical shape of openings
15 dome-shaped covering
16 main part of grate
17 drive shaft
18 combustion air
19 gasifier component
20 oxidation zone
21 gasifier container
22 ring gap
23 ring
24 pillared insert
25 upper cover
26 lower cover
27 open end of gasifier component
28 closed end of gasifier component
29 motor drive
30 distance between grate and open end
31 diameter of grate
32 inner diameter of gasifier container
33 supports for ring
34 supply inlet
35 air supply inlet
36 level sensor
37 inspection shaft
38 covering flange
39 temperature measurement device
40 product gas vent
41 heat exchanger
42 cyclone separator
43 gas outlet
44 inner diameter of gasifier component
45 first end of drive shaft
46 second end of drive shaft
47 upper side of grate
48 lower side of grate
49 grating surface area

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-8. (canceled)

9. A rotary grate for use in a fixed-bed gasifier that produces a product gas from hydrocarbon-containing feedstock, comprising:
a disk-shaped main part adapted to support the hydrocarbon-containing feedstock inside the fixed-bed gasifier, wherein the disk-shaped main part includes an upper side, a lower side, a middle and slit-shaped openings, wherein each of the slit-shaped openings has a cross-section that conically widens in a direction from the upper side to the lower side;
a central drive shaft having a first end and a second end, wherein the first end of the central drive shaft is fixedly attached to the middle of the disk-shaped main part; and
a dome-shaped covering disposed in the middle of the disk-shaped main part, wherein the dome-shaped covering is attached to the upper side of the disk-shaped main part opposite to where the central drive shaft is attached to the lower side of the disk-shaped main part.

10. The rotary grate of claim 9, wherein the slit-shaped openings extend concentrically around the middle of the disk-shaped main part and are radially distributed over the disk-shaped main part.

11. The rotary grate of claim 9, wherein the upper side of the disk-shaped main part outside the dome-shaped covering provides a grating surface area, and wherein a combined open area formed by the slit-shaped openings on the upper side of the disk-shaped main part makes up between 20% to 40% of the grating surface area on the upper side of the disk-shaped main part.

12. The rotary grate of claim 9, wherein a motor drive is connected to the second end of the central drive shaft.

13. The rotary grate of claim 9, wherein the slit-shaped openings are adapted to act as a plane to break up objects disposed on the upper side of the disk-shaped main part as the central drive shaft rotates the disk-shaped main part.

14. The rotary grate of claim 13, wherein the objects are ash produced by the gasification of the hydrocarbon-containing feedstock into the product gas.

15. A fixed-bed gasifier for producing a product gas from biomass particles, comprising:
a gasifier container;
a supply inlet adapted to receive the biomass particles into the fixed-bed gasifier;
an air supply inlet through which combustion air enters the gasifier container;
a rotary grate adapted to support the biomass particles that is disposed in a lower portion of the gasifier container, wherein the grate includes an upper side, a lower side and slit-shaped openings; and
a product gas vent leading out of the gasifier container below the rotary grate and through which the product gas generated from the biomass particles exits the gasifier container, wherein each of the slit-shaped openings has a cross-section that conically widens in a direction from the upper side to the lower side of the rotary grate.

16. The fixed-bed gasifier of claim 15, wherein the gasifier container has a first diameter, further comprising:
a gasifier component with a second diameter, an upper closed end and a lower open end, wherein the first diameter is larger than the second diameter, wherein the lower open end of the gasifier component extends down into the gasifier container, wherein both the supply inlet and the air supply inlet enter into the upper closed end of the gasifier component,

17. The fixed-bed gasifier of claim 15, wherein the gasifier container has an inner wall and an inner diameter, wherein the rotary grate has a diameter that is smaller than the inner diameter of the gasifier container such that a ring gap remains between the rotary grate and the inner wall of the gasifier container, and wherein a ring is disposed in the ring gap.

18. The fixed-bed gasifier of claim 17, wherein the gasifier container has a lower cover, and wherein the ring is supported from the lower cover by supports.

19. The fixed-bed gasifier of claim 17, wherein the gasifier container has an upper cover, and wherein pillared inserts disposed inside the gasifier container extend from the ring to the upper cover.

20. The fixed-bed gasifier of claim 17, wherein the gasifier container has a lower cover and an upper cover, and wherein pillared inserts are disposed inside the gasifier container and extend from the lower cover to the upper cover.

21. The fixed-bed gasifier of claim 15, further comprising:
a gasifier component that is arranged coaxially with respect to the gasifier container, wherein the gasifier component is disposed above the rotary grate.

22. The fixed-bed gasifier of claim 15, wherein the rotary grate is rotatable.

23. The fixed-bed gasifier of claim 15, wherein the slit-shaped openings are adapted to act as a plane as the rotary grate rotates to break up objects supported by the rotary grate.
